(19) United States
(12) Patent Application Publication
(10) Pub. No.: US 2025/0079907 A1
(43) Pub. Date: Mar. 6, 2025

(54) Wireless Power Transfer Relay

(71) Applicant: ohSnap, Inc., Apex, NC (US)

(72) Inventors: David Paul Echem, Apex, NC (US); Peter James Diemer, Mocksville, NC (US); Dale Christopher Backus, Broadway, NC (US); Eric Lucas Epstein, Durham, NC (US)

(21) Appl. No.: 18/816,545

(22) Filed: Aug. 27, 2024

Related U.S. Application Data
(60) Provisional application No. 63/580,927, filed on Sep. 6, 2023.

(51) Int. Cl. H02J 50/50; H02J 7/00; H02J 50/12; H02J 50/70; H02J 50/80; H02J 50/90

(52) U.S. Cl. CPC H02J 50/50; H02J 7/0044; H02J 50/12; H02J 50/70; H02J 50/80; H02J 50/90

(57) ABSTRACT

In one embodiment, a wireless power transfer relay for coupling to a mobile electronic device is provided. The wireless power transfer relay includes a receiving platform having a relay receiver coil, a transmitting platform having a relay transmitter coil, and a conductor coupled between the receiving platform and the transmitting platform and electrically coupling the relay receiver coil and the relay transmitter coil. The relay receiver coil is configured in proximity to a primary transmitter coil of a wireless power transmitter to wirelessly receive power from the primary transmitter coil. The relay transmitter coil is configured in proximity to a primary receiver coil of the mobile electronic device to wirelessly transmit power to the primary receiver coil.

### PRIORITY

This application claims the benefit under 35 U.S.C. § 119(e) of U.S. Provisional Patent Application No. 63/580,927, filed 6 Sep. 2023, which is incorporated herein by reference.

### TECHNICAL FIELD

This disclosure generally relates to wireless power transfer of electronic devices, and in particular relates to a wireless power transfer relay.

### BACKGROUND

Wireless power transfer of electrical energy involves sending electromagnetic energy from a transmitter to a receiver, where it is converted into useful forms of energy. Essentially, it functions like a transformer with transmitting and receiving coils that are not directly coupled but separated by a gap in between (typically air or other insulating materials). In the world of consumer electronics, mobile electronic devices such as mobile phones may be charged wirelessly without the need to plug in a physical cable to the device. This provides better ruggedness of the device (e.g., water resistance with no or fewer ports) and promotes the standardization of wireless charging, leading to fewer cables and proprietary chargers. However, convenient accessory devices that can be attached to consumer electronics will often cover and block conventional receiver coils used for wireless charging. This means the attached accessory must either be removed from the device or made of non-conductive materials thin enough to allow for the relatively short distances needed for wireless power transfer. With few exceptions, most accessories would need to be removed due to their metallic construction and/or relatively large thickness for the electronic device to be wirelessly charged, causing a common complaint. Moreover, since the receiving coil needs to be located very close to the charger coil, the distance between the electronic device and the charger during wireless power transmission is constrained to a very limited range.

It would be more convenient to allow the device being charged to be separated from the wireless charger at a greater distance, and possibly with accessories between the device and wireless charger without sacrificing energy transfer efficiency.

### SUMMARY OF PARTICULAR EMBODIMENTS

Particular embodiments according to this disclosure present a wireless power transfer relay that may be configured to relay power from a wireless power transmitter to a mobile electronic device, allowing the mobile electronic device to be separated from the wireless power transmitter at a greater distance while still ensuring effective wireless charging. Objects or accessories may be sandwiched between components of the wireless power transfer relay. This way, thick and/or conductive devices such as cases, grips, wallets, stands, etc. that are incompatible with or form barriers to wireless power transfer may be left on the mobile electronic device during wireless charging. Additionally or alternatively, by means of the wireless power transfer relay disclosed herein, the mobile electronic device may be positioned at any desired distance away from the wireless power transmitter without necessarily being restricted to the typical allowable range for wireless power transfer.

In particular embodiments, a wireless power transfer relay for coupling to a mobile electronic device is provided. The wireless power transfer relay includes a receiving platform having a relay receiver coil, a transmitting platform having a relay transmitter coil, and a conductor coupled between the receiving platform and the transmitting platform and electrically coupling the relay receiver coil and the relay transmitter coil. The relay receiver coil is configured in proximity to a primary transmitter coil of a wireless power transmitter to wirelessly receive power from the primary transmitter coil. The relay transmitter coil is configured in proximity to a primary receiver coil of the mobile electronic device to wirelessly transmit power to the primary receiver coil.

In particular embodiments, the relay receiver coil and the relay transmitter coil are spaced apart by a distance that would affect wireless power transfer efficiency.

In particular embodiments, the distance is greater than a maximum allowable distance for wireless charging.

In particular embodiments, the relay receiver coil is configured to wirelessly receive a maximum amount of power from the primary transmitter coil.

In particular embodiments, the relay receiver coil and the relay transmitter coil are configured for induction charging.

In particular embodiments, the wireless power transfer relay further includes one or more ferrite backings coupled to one or more of the receiving platform or the transmitting platform. The one or more ferrite backings are configured to shield a magnetic field generated by the primary transmitter coil beyond the relay receiver coil.

In particular embodiments, the wireless power transfer relay further includes one or more magnet arrays coupled to one or more of the receiving platform or the transmitting platform for position alignment.

In particular embodiments, the wireless power transfer relay further includes a pair of near-field communication (NFC) relay coils configured to relay an NFC signal between the wireless power transmitter and the mobile electronic device.

In particular embodiments, the conductor includes one or more of a wire, a pin, or a contact.

In particular embodiments, the receiving platform and the transmitting platform are movably connected via a hinge.

In particular embodiments, the wireless power transfer relay further includes an accessory device positioned between the receiving platform and the transmitting platform.

In particular embodiments, the accessory device includes one or more of a case, a grip, or a wallet.

In particular embodiments, the wireless power transfer relay further includes a container space positioned between the receiving platform and the transmitting platform.

In particular embodiments, the wireless power transfer relay further includes a capacitor connected to the relay transmitter coil. The capacitor is configured to adjust a resonant frequency of the relay transmitter coil.

In particular embodiments, the wireless power transfer relay further includes a microcontroller unit connected to the relay transmitter coil. The microcontroller unit is configured to monitor an operating frequency of the wireless power transmitter or the mobile electronic device.

In particular embodiments, the transmitting platform is configured to be coupled to the mobile electronic device via one or more of a magnet, an adhesive, or a mechanical connector.

In particular embodiments, the receiving platform and the transmitting platform are separable from each other.

In particular embodiments, the relay receiver coil and the relay transmitter coil are spaced apart in an axial direction.

In particular embodiments, the relay receiver coil and the relay transmitter coil are spaced apart in a transverse direction.

In particular embodiments, a wireless power transfer relay for coupling to a mobile electronic device is provided. The wireless power transfer relay includes a receiving platform having a relay receiver coil, a transmitting platform having a relay transmitter coil, a conductor coupled between the receiving platform and the transmitting platform and electrically coupling the relay receiver coil and the relay transmitter coil, and an accessory device positioned between the receiving platform and the transmitting platform. The relay receiver coil is configured in proximity to a primary transmitter coil of a wireless power transmitter to wirelessly receive power from the primary transmitter coil. The relay transmitter coil is configured in proximity to a primary receiver coil of the mobile electronic device to wirelessly transmit power to the primary receiver coil. The accessory device has a thickness that would affect wireless power transfer efficiency.

In particular embodiments, a wireless power transfer relay for coupling to a mobile electronic device is provided. The wireless power transfer relay includes a receiving platform having a relay receiver coil, a transmitting platform having a relay transmitter coil, a conductor coupled between the receiving platform and the transmitting platform and electrically coupling the relay receiver coil and the relay transmitter coil, and a container space positioned between the receiving platform and the transmitting platform. The relay receiver coil is configured in proximity to a primary transmitter coil of a wireless power transmitter to wirelessly receive power from the primary transmitter coil. The relay transmitter coil is configured in proximity to a primary receiver coil of the mobile electronic device to wirelessly transmit power to the primary receiver coil. The container space has a thickness that would affect wireless power transfer efficiency.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example mobile electronic device and an example wireless power transmitter.

FIG. 2 illustrates an example circuit diagram of a primary receiver coil of the mobile electronic device and a primary transmitter coil of the wireless power transmitter.

FIG. 3 illustrates an example wireless power transfer relay, which is positioned between the mobile electronic device and the wireless power transmitter.

FIG. 4 illustrates an example circuit diagram of a relay receiver coil and a relay transmitter coil of the wireless power transfer relay, which are respectively positioned in proximity to the primary transmitter coil and the primary receiver coil.

FIG. 5 illustrates an example circuit diagram of the wireless power transfer relay with the addition of circuit components.

FIG. 6 illustrates the wireless power transfer relay positioned on the wireless power transmitter.

FIG. 7 illustrates a standalone view of the wireless power transfer relay.

FIG. 8 illustrates an example wireless power transfer relay, which is configured as a multi-panel system.

FIG. 9 illustrates the wireless power transfer relay having ferrite backings.

FIG. 10 illustrates the wireless power transfer relay having NFC relay coils.

FIG. 11 illustrates the NFC relay coils in isolation.

FIGS. 12-13 illustrate an example wireless power transfer relay configured as an integrated module.

FIG. 14 illustrates an example wireless power transfer relay configured with a hinge.

FIG. 15 illustrates an example wireless power transfer relay configured to relay power in a transverse direction.

FIGS. 16-17 illustrate example use cases of the wireless power transfer relay of FIG. 15.

### DESCRIPTION OF EXAMPLE EMBODIMENTS

Particular embodiments of this disclosure are directed to a wireless power transfer relay, which may be configured to receive wireless power from a wireless power transmitter and relay the energy to a mobile electronic device to wirelessly charge it. This way, the mobile electronic device may be positioned at a desired distance from the wireless power transmitter while still guaranteeing proper charging. Moreover, accessories or other objects may stay attached to the mobile electronic device without having to be removed.

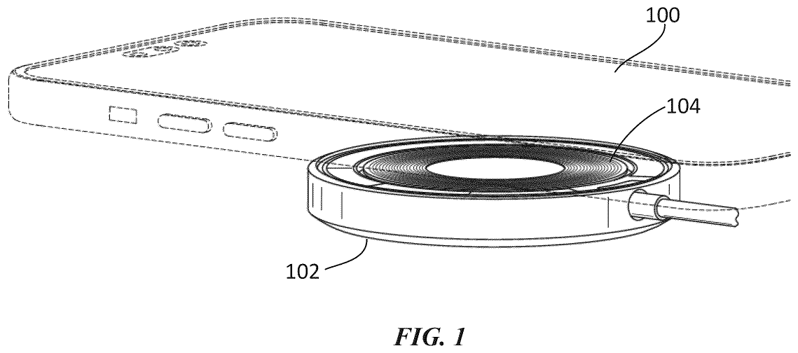

FIG. 1 illustrates an example mobile electronic device 100 and an example wireless power transmitter 102 during wireless charging. Although the mobile electronic device 100 and the wireless power transmitter 102 are illustrated in the figures as particular devices with particular shapes, sizes, and configurations in a particular manner, this disclosure contemplates any mobile electronic devices and any wireless power transmitters with any suitable shapes, sizes, and configurations in any suitable manner. As an example and not by way of limitation, the mobile electronic device 100 may be a smartphone, a cellular telephone, a tablet computer, a laptop computer, a wearable electronic device, a digital media player, and other suitable mobile electronic devices. As an example and not by way of limitation, the wireless power transmitter 102 may be a wireless charging base, a wireless charging dock, a wireless charging pad, a wireless charging platform, and other suitable wireless power transmitters, which, for example, may be a standalone device or incorporated into other charging devices or systems such as incorporated into a vehicle-mounted charging system.

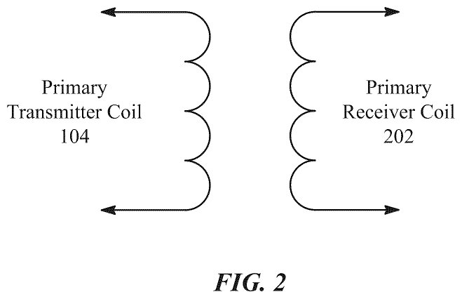

In particular embodiments, as illustrated, the mobile electronic device 100 may be placed on or in proximity to the wireless power transmitter 102 during wireless charging to receive wireless power from the wireless power transmitter 102. In particular embodiments, the wireless power transmitter 102 may be an alternating current (AC) charging base station that is configured to produce AC signals. As an example and not by way of limitation, the wireless power transmitter 102 may be connected to an AC power source such as a household power source, a vehicle-mounted power source, or other suitable power sources. As an example and not by way of limitation, if desired, the wireless power transmitter 102 may be connected to a direct current (DC) power source such as a battery and configured to convert the received DC power into AC signals. In particular embodiments, the wireless power transmitter 102 may include a primary transmitter coil 104, which may generate an oscillating magnetic or electromagnetic field when energized based on the received electric power from the power source. To be powered by the wireless power transmitter 102, in particular embodiments, the mobile electronic device 100 may include a primary receiver coil (e.g., the primary receiver coil 202 of FIG. 2), which, for example, may be integrated inside the body of the mobile electronic device 100 and configured to capture the magnetic field generated by the primary transmitter coil 104 of the wireless power transmitter 102 in order to allow wireless charging of the mobile electronic device 100.

FIG. 2 illustrates an example circuit diagram of the primary transmitter coil 104 of the wireless power transmitter 102 and the primary receiver coil 202 of the mobile electronic device 100. In particular embodiments, for effectively charging the mobile electronic device 100 through the wireless power transmitter 102, the primary receiver coil 202 may be placed in proximity to and substantially in alignment with (such as substantially concentric with or overlap with) the primary transmitter coil 104 such that the primary receiver coil 202 is substantially or entirely exposed to the magnetic field generated by the energized primary transmitter coil 104. In particular embodiments, during wireless charging, the primary receiver coil 202 may be configured to capture most, if not all, of the generated magnetic field, which may in turn induce an alternating current in the primary receiver coil 202, thereby charging one or more batteries or other suitable power sources of the mobile electronic device 100 that are electrically coupled to the primary receiver coil 202. This may generally be known in the industry as magnetic induction charging. Example specifications of such wireless charging technology may include QI, QI-2, and other suitable wireless charging specifications, which may ensure compatibility across different types and configurations of devices. Efficient charging typically requires close proximity and proper alignment between the primary transmitter coil of the wireless power transmitter and the primary receiver coil of the mobile electronic device. However, in everyday situations, it may be inconvenient to always have the two primary coils be closely positioned. For example, there may be an accessory device coupled to the back of the mobile electronic device (such as a case, a grip, a wallet, a battery bank, etc.), which separates or blocks the primary receiver coil from the primary transmitter coil, requiring a user to remove the accessory device before wireless charging the mobile electronic device. Or sometimes it may be difficult to align the two primary coils due to position constraints. Therefore, a solution is desired to allow for greater charging distance or flexibility in positioning the devices without sacrificing charging efficiency and/or to allow the accessory to remain attached during wireless charging.

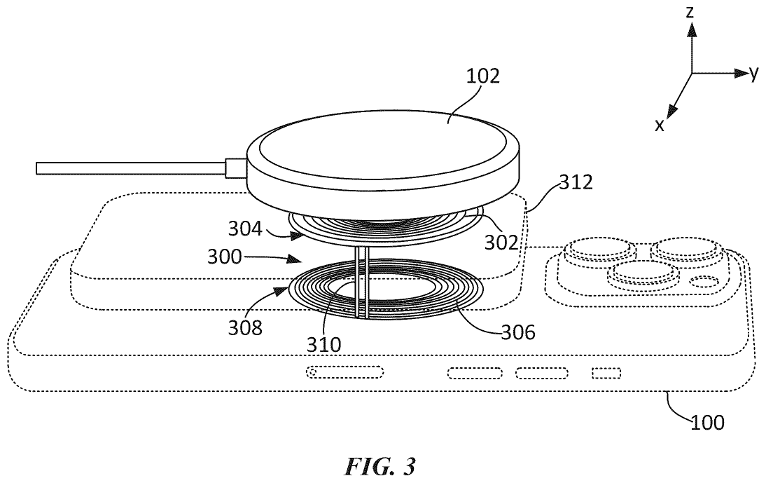

FIG. 3 illustrates a wireless power transfer relay 300 in accordance with an embodiment of this disclosure. In particular embodiments, the wireless power transfer relay 300 may be positioned between the mobile electronic device 100 and the wireless power transmitter 102 and may be configured to relay the power received from the wireless power transmitter 102 to the mobile electronic device 100, allowing effective wireless charging without requiring the mobile electronic device 100 and the wireless power transmitter 102 to be closely positioned. In particular embodiments, the wireless power transfer relay 300 may include a relay receiver coil 302 at a receiving platform 304, which may be placed in proximity to the wireless power transmitter 102, and a relay transmitter coil 306 at a transmitting platform 308 distant from the receiving platform 304. As an example and not by way of limitation, during wireless charging, the relay receiver coil 302 may be located in proximity to the primary transmitter coil 104 of the wireless power transmitter 102, while the relay transmitter coil 306 may be located in proximity to the primary receiver coil 202 of the mobile electronic device 100. In particular embodiments, the relay receiver coil 302 may be configured to capture wireless power from the wireless power transmitter 102, which may in turn induce an alternating current in the relay receiver coil 302. In other words, the relay receiver coil 302 may function similarly as a primary receiver of wireless power from the wireless power transmitter 102, receiving most, if not all, of the generated magnetic flux and converting it into electrical current. The induced current may be conducted, for example, via one or more conductors 310, to the relay transmitter coil 306, which may re-radiate the power to the primary receiver coil 202 via the relay transmitter coil 306, thereby wirelessly charging the mobile electronic device 100 (e.g., by induction charging as discussed above). Configured as such, power from the wireless power transmitter 102 may be relayed to the mobile electronic device 100 through the wireless power transfer relay 300, allowing the mobile electronic device 100 to be located at a desired standoff distance from the wireless power transmitter 102 while still ensuring proper charging efficiency.

In particular embodiments, the conductor 310 may be provided between the receiving platform 304 and the transmitting platform 308 and electrically couple or connect the relay receiver coil 302 and the relay transmitter coil 306 together. As an example and not by way of limitation, the conductor 310 may take form as one or more leads, single wires, bundled wires, pins, or other suitable connectors extending between the relay receiver and transmitter coils 302 and 306 to transmit electric energy. In particular embodiments, the conductor 310 may have any suitable length (e.g., either fixed or adjustable), allowing the two relay coils 302 and 306 to be positioned at any suitable distance relative to each other.

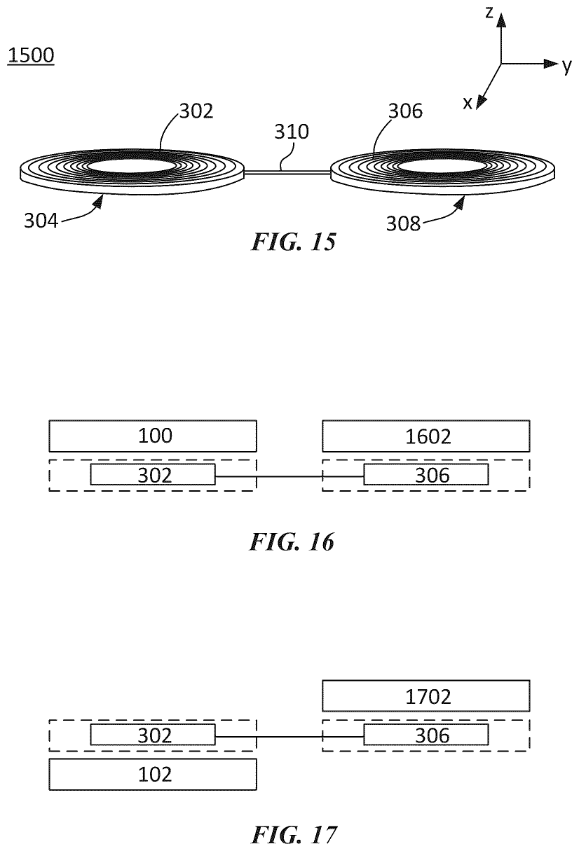

In particular embodiments, the two relay coils 302 and 306, or the receiving and transmitting platforms 304 and 308, may be separated by a specified distance. As an example and not by way of limitation, the specified distance may be fixed or adjustable. As an example and not by way of limitation, the specified distance may be a value that affects wireless power transfer efficiency. As an example and not by way of limitation, the specified distance may be greater than a maximum allowable distance for wireless charging (typically, for maintaining a stable wireless power transmission, a distance between a receiver and a transmitter may range from 2 mm to 10 mm). As an example and not by way of limitation, the specified distance may still permit wireless power transfer. As an example and not by way of limitation, the specified distance between the two relay coils 302 and 306 may be greater than 2 mm, greater than 3 mm, greater than 4 mm, greater than 5 mm, greater than 6 mm, greater than 7 mm, greater than 8 mm, greater than 9 mm, greater than 10 mm, or more. By configuring the relay receiver and transmitter coils 302 and 306 to be separable, this may allow an accessory device 312 (such as a case, a wallet, grip, a battery bank, etc.) to be placed between the relay coils 302 and 306 during wireless charging, which contrasts conventional configuration that typically requires the attached accessory to be removed before wirelessly charging the mobile electronic device. In other words, device such as phone case or grip that is either too thick to allow for efficient or high-power wireless charging or contains metallic, conductive, or magnetic materials that prohibit wireless charging may be allowed to stay attached. With the wireless power transfer relay 300, the material type or thickness of the accessory device 312 may be chosen in disregard to how it will impact wireless charging since the wireless power transfer relay 300 may circumvent the obstacles. Additionally or alternatively, with the wireless power transfer relay 300, the mobile electronic device 100 does not need to be placed close to the wireless power transmitter 102 to enable wireless charging. As an example and not by way of limitation, in the embodiment as shown, the relay receiver coil 302 may be spaced from yet remain aligned with the relay transmitter coil 306 along the same vertical axis (e.g., along the axial z direction). As an example and not by way of limitation, while not shown, the relay receiver coil 302 may be disposed off-axis (i.e., non-concentric) relative to the relay transmitter coil 306. As an example and not by way of limitation, the relay receiver coil 302 and the relay transmitter coil 306 may be separated in any suitable direction (such as transversely offset in the x-y plane, as illustrated in FIG. 15).

In particular embodiments, as discussed, the accessory device 312 may stay attached to the mobile electronic device 100 (e.g., on its back panel) during wireless charging. Specifically, as an example and not by way of limitation, the accessory device 312 may be positioned in a spacing between the relay receiver coil 302 and the relay transmitter coil 306 of the wireless power transfer relay 300. Convenient accessory devices may typically be made of magnetic or conductive materials such as metal and may often be too thick to reliably establish wireless power transfer therethrough. In particular embodiments, however, since power transmission between the two relay coils 302 and 306 is relayed through the conductor 310 having the desired length, reliable transfer of electric energy may be ensured regardless of the material construction or thickness of the attached accessory device 312. In other words, conductive or thick accessory devices 312 that would otherwise interfere with or disrupt wireless power transfer are allowed to be simply left attached to the mobile electronic device 100 during wireless charging. In particular embodiments, the accessory device 312 may have a thickness that would affect wireless power transfer efficiency. In particular embodiments, the accessory device 312 may have a thickness that is greater than the maximum allowable distance for wireless charging as discussed above. In particular embodiments, the accessory device 312 may have a thickness that would still permit wireless power transfer.

In particular embodiments, the relay receiver coil 302 and the relay transmitter coil 306 may be built into the accessory device 312. As an example and not by way of limitation, the relay receiver coil 302 may be embedded in or coupled to one surface of the accessory device 312 facing the wireless power transmitter 102, and the relay transmitter coil 306 may be embedded in or coupled to the other surface of the accessory device 312 facing the mobile electronic device 100. In particular embodiments, the conductor 310 may as well be integrated into the accessory device 312. As an example and not by way of limitation, the conductor 310 may be routed through the accessory device 312 in its side walls between the two surfaces so as to electrically connect the two relay coils 302 and 306.

In particular embodiments, the wireless power transfer relay 300 may be implemented as a standalone device that may be coupled to the accessory device 312 or the mobile electronic device 100 itself in a way that allows the accessory device 312 to sit between the receiving platform 304 and the transmitting platform 308 during wireless charging. As an example and not by way of limitation, the wireless power transfer relay 300 may be coupled, via its transmitting platform 308, to the back side of the mobile electronic device 100 using a magnet, an adhesive, a mechanical connector, etc. As an example and not by way of limitation, the transmitting platform 308 of the wireless power transfer relay 300 may be configured as a sticker-based device with a substrate that is adherable to the back side of the mobile electronic device 100 via an adhesive, and into which the relay transmitter coil 306 may be integrated or embedded. As an example and not by way of limitation, the wireless power transfer relay 300 may be coupled to the accessory device 312 using a magnet, an adhesive, a mechanical connector, etc.

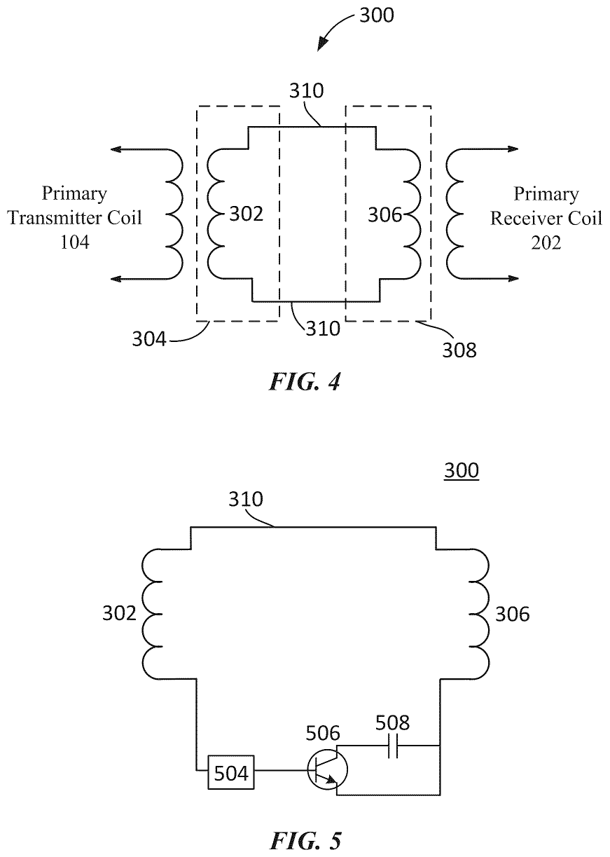

FIG. 4 illustrates an example circuit diagram of the wireless power transfer relay 300, which may be positioned between the wireless power transmitter 102 and the mobile electronic device 100, with the relay receiver coil 302 in proximity to the primary transmitter coil 104 and the relay transmitter coil 306 in proximity to the primary receiver coil 202. In particular embodiments, the relay receiver coil 302 may be designed similarly to the primary transmitter coil 104 of the wireless power transmitter 102 in size and/or shape. In particular embodiments, the relay receiver coil 302 may be dimensioned or wound with a number of wired loops in a way to be able to maximally intersect the magnetic field of the wireless power transmitter 102 while still keeping the inductance of the system relatively unchanged from the value expected by the wireless power transmitter 102. As an example and not by way of limitation, the relay receiver coil 302 may be configured to avoid triggering Foreign Object Detection (FOD) by the wireless power transmitter 102, which could otherwise cause the wireless power transmitter 102 to reduce or cease output. FOD may generally refer to a system's ability to identify and respond to the presence of unintended metallic or conductive objects placed between a charging device (e.g., transmitter) and a device being charged (e.g., receiver). Specifically, for example, during wireless charging, information may be exchanged between the transmitter and the receiver, and a decision may be made about the foreign object presence based on the exchanged information. For example, in response to determining that there exists an information mismatch between the transmitter and the receiver, which indicates a possible presence of foreign object, power output from the transmitter may be adjusted—such as by reducing the output to a lower level or suspending power transmission entirely—to prevent any potential hazards like heating of the foreign object. To avoid triggering FOD and ensure proper energy transmission, in particular embodiments, the relay receiver coil 302 may be configured to receive an amount of power expected by the wireless power transmitter 102. As an example and not by way of limitation, the relay receiver coil 302 may receive 90%-100% of the total power emitted by the wireless power transmitter 102. Alternatively or additionally, in particular embodiments, the relay receiver coil 302 may be dimensioned to minimize the effect on the system's operating frequency.

In particular embodiments, the relay transmitter coil 306 may be designed similarly to the primary receiver coil 202 of the mobile electronic device 100 in size and/or shape. In particular embodiments, the relay transmitter coil 306 may be dimensioned or wound with a number of wired loops in a way to be able to deliver an amount of wireless power output expected by the mobile electronic device 100, for example, for optimal energy efficiency and to avoid triggering FOD by the mobile electronic device 100. In particular embodiments, the relay transmitter coil 306 may be designed to maximize the magnetic flux through the primary receiver coil 202 of the mobile electronic device 100.

In particular embodiments, the relay transmitter coil 306 may be of the same or similar design as the relay receiver coil 302. In this regard, as an example and not by way of limitation, the two relay coils 302 and 306 may be used interchangeably—i.e., positions of the two relay coils may be swapped such that the relay transmitter coil may function as a receiver, and the relay receiver coil a transmitter. As another example and not by way of limitation, the relay transmitter coil 306 may be wound in the same direction with the same number of wire loops as the relay receiver coil 302.

In particular embodiments, one or more of the relay receiver coil 302 or the relay transmitter coil 306 may be configured with suitable numbers, diameters, or shapes of wires to help reduce Ohmic losses (also known as resistive losses, which refer to the energy lost in the form of heat), proximity effect (i.e., an increase in resistance when conductors carrying current in the same direction are placed close together), skin effect (which causes current to concentrate near the surface of the conductor, increasing resistance and losses), or other various factors that negatively affect charging efficiency. As an example and not by way of limitation, the relay coils 302 and/or 306 may include 500, 600, 700, 800, 900, 1000, or more number of wires. As an example and not by way of limitation, the wire may have a diameter of about 0.05 mm, 0.04 mm, 0.03 mm, 0.02 mm, 0.01 mm, or less. As an example and not by way of limitation, the wires may be grouped together into a single bundle and looped to form the coil. Specifically, as an example and not by way of limitation, the relay coils 302 and/or 306 may include 800 wires, each having a diameter of 0.03 mm, stranded and looped. As an example and not by way of limitation, litz wire may be used, which is a type of specialized wire suitable for high-frequency applications, delivering efficient power transmission.

While described in this way, it will nevertheless be understood that the embodiments disclosed herein are not limited to such coil configurations. In this regard, although this disclosure describes a wireless power transfer relay with a particular relay coil in a particular manner, this disclosure contemplates wireless power transfer relays with any suitable relay coils in any suitable manner. As an example and not by way of limitation, one or more of the relay coils 302 or 306 may be adjusted smaller or larger or configured with various different shapes (such as circular, elliptical, triangular, rectangular, polygonal, non-polygonal, irregular in shape, etc.). As an example and not by way of limitation, the relay coils 302 and 306 may be configured as closed loops of coils with any suitable shape, size, number of coils, and coil material. As an example and not by way of limitation, configurations of the two relay coils 302 and 306 may be similar to or different from those currently used in wireless chargers or receivers.

In particular embodiments, the wireless power transfer relay 300 may be configured to adapt between QI and QI-2 charging standards. In particular embodiments, the receiving platform 304 of the wireless power transfer relay 300 having the relay receiver coil 302 may be configured as a non-magnetic pad or base for coupling a wireless power transmitter with QI specification. As an example and not by way of limitation, the receiving platform 304 may have any suitable size and geometry (e.g., circular, elliptical, rectangular, etc.) and may be customizable or manufacturer-specific to accommodate different wireless power transmitters. As another example and not by way of limitation, the receiving platform 304 may be made of rubber or other suitable deformable materials to adapt to different charging locations. On the other hand, as an example and not by way of limitation, the transmitting platform 308 of the wireless power transfer relay 300 having the relay transmitter coil 306 may be provided with a QI-2 compliant magnet array, which may be configured to interact with a corresponding magnet array of the mobile electronic device 100, ensuring proper alignment between the relay transmitter coil 306 and the primary receiver coil 202 for efficient wireless charging. For example, this may be helpful in scenarios where a user finds it difficult to align the mobile electronic device 100 with the wireless power transmitter 102 due to their different charging standards (e.g., when charging a QI-2 standard smartphone on a vehicle-mounted charging platform with no magnetic alignment). In particular embodiments, QI and QI-2 configurations of the wireless power transfer relay 300 as described may be reversed if desired so that the receiving platform 304 is QI-2 compliant with magnetic alignment while the transmitting platform 308 is under the non-magnetic QI standard.

In particular embodiments, the wireless power transfer relay 300 may be configured to convert between different charging parameters and accommodate different types of devices having different shapes and/or sizes. As an example and not by way of limitation, the receiving platform 304 may be configured as a large charging pad suitable for receiving wireless power under QI specification, and the transmitting platform 308 may be configured as a small charging dock for charging wearable electronic devices such as a smartwatch, earbuds, and so forth. As an example and not by way of limitation, the receiving platform 304 may be provided with a QI-2 compliant magnet array, and the transmitting platform 308 may be a small charging dock for charging wearable electronic devices such as a smartwatch, earbuds, and so forth. As an example and not by way of limitation, the transmitting platform 308 may be configured as an integrated charging platform suitable for simultaneously charging multiple electronic devices.

In particular embodiments, the wireless power transfer relay 300 may be configured to passively receive the magnetic flux from the wireless power transmitter 102 and transmit power to the mobile electronic device 100. Alternatively or additionally, in particular embodiments, the wireless power transfer relay 300 may be configured as an active participant in power transmission that actively captures the magnetic flux from the wireless power transmitter 102 at a desired level and generates a suitable output to the mobile electronic device 100. As an example and not by way of limitation, the relay receiver coil 302 and the relay transmitter coil 306 may respectively be in communication with the wireless power transmitter 102 and the mobile electronic device 100 to negotiate power input and output.

FIG. 5 illustrates an example circuit diagram of the wireless power transfer relay 300, which may be provided with one or more circuit components such as capacitors, transistors, microcontrollers, printed circuit board assemblies (PCBAs), etc. configured to regulate the frequency of the wireless power transfer relay 300. As an example and not by way of limitation, a capacitor may be provided, which may be configured to adjust the resonance or impedance of the wireless power transfer relay 300 to a specified level. In particular embodiments, the wireless power transfer relay 300 may be able to tune its resonance from a lower frequency band to a higher frequency band (such as from about 128kHz to 360kHz) or vice versa to accommodate different power limits of the transmitting or receiving device. In particular embodiments, an active circuit component such as a microcontroller unit 504 may be provided in the circuitry. As an example and not by way of limitation, the microcontroller unit 504 may be able to detect or monitor an operating frequency of the mobile electronic device 100 and/or the wireless power transmitter 102, and the resonance of the wireless power transfer relay 300 may be tuned to generally match the operating frequency (e.g., based on the impedance and one or more tuning capacitors) so as to reduce frequency mismatch, allowing efficient charging and reducing power loss. For example, in practice, in scenarios where the wireless power transmitter 102 is QI-2 compliant, its charging frequency may start at about 128 kHz in the initial negotiation phase (i.e., when the transmitter and the receiver exchange information to establish a suitable power transfer rate). On the other hand, the mobile electronic device 100 similarly under the QI-2 standard may have a full QI-2 capability of up to about 360 kHz in frequency (e.g., when charging an IPHONE). After recognizing the maximum allowable frequency of the receiving device, the wireless power transmitter 102 may switch its output to the higher frequency band, delivering wireless power at full capacity. Alternatively or additionally, if it is determined that the mobile electronic device 100 is suitable for operating in the 128 kHz band (e.g., when charging an ANDROID device), the wireless power transmitter 102 may maintain power delivery in this low-frequency range.

In particular embodiments, the resonant frequency of the wireless power transfer relay 300 may be tunable so that it may accommodate different operating frequency specifications. As an example and not by way of limitation, the microcontroller unit 504 may be able to detect or monitor the charging frequency of the wireless power transmitter 102 or the charging frequency the mobile electronic device 100 can or is receiving (e.g., 360 kHz for IPHONE and 128 kHz for ANDROID devices), and the resonance or impedance of the wireless power transfer relay 300 may be tuned so that it may operate more efficiently at resonance, which is determined knowing the charging frequency, thereby optimizing power transfer rate for efficient charging while ensuring operation safety and preventing damage or overheating. As an example and not by way of limitation, a transistor 506 may be connected with the microcontroller unit 504 and configured to switch the circuit, based on frequency detection of the microcontroller unit 504, between a low resonant frequency level and a high resonant frequency level (e.g., a capacitor 508 may be connected in the high output branch for tuning the resonance to the high frequency). In particular embodiments, the wireless power transfer relay 300 may continue to communicate with the wireless power transmitter 102 and/or the mobile electronic device 100 throughout the charging process to adjust the power levels in real time as needed.

In particular embodiments, the resonance of the wireless power transfer relay 300 may be tunable such that multiple frequencies may cause resonance, which for example may be based on or inherent to the geometry and configuration of the coils, capacitors, or other circuit components. As an example and not by way of limitation, in this case, the microcontroller unit 504 may no longer be needed since the wireless power transfer relay 300 may already be capable of resonating at the desired frequencies.

In particular embodiments, as discussed, the wireless power transfer relay 300 may be configured to keep the resonant frequency fixed to the value expected by the wireless power transmitter 102 and the mobile electronic device 100 since the digital communication between the two is in-band (i.e., they modulate the power signal to carry the communication). Alternatively or additionally, in particular embodiments, the two sides of the wireless power transfer relay 300 (e.g., the receiving and transmitting platforms 304 and 308) may be configured to operate separately. In other words, the receiving platform 304 and the transmitting platform 308 may handle digital communication independently from one another, allowing for different frequencies on either side.

In particular embodiments, the wireless power transfer relay 300 may be compatible with particular brands, manufacturers, or models of mobile electronic devices and wireless power transmitters. As an example and not by way of limitation, the wireless power transfer relay 300 may be compatible with an APPLE device (e.g., an IPHONE), an ANDROID device, and other suitable devices. As an example and not by way of limitation, the wireless power transfer relay 300 may be universally compatible with multiple (or all) brands, manufacturers, and models (e.g., both APPLE and ANDROID devices). In particular embodiments, the wireless power transfer relay 300 may be compliant with particular wireless power transmission specifications such as QI, QI-2, and other suitable specifications. In particular embodiments, the wireless power transfer relay 300 may be compliant with particular power connector specifications such as APPLE MAGSAFE.

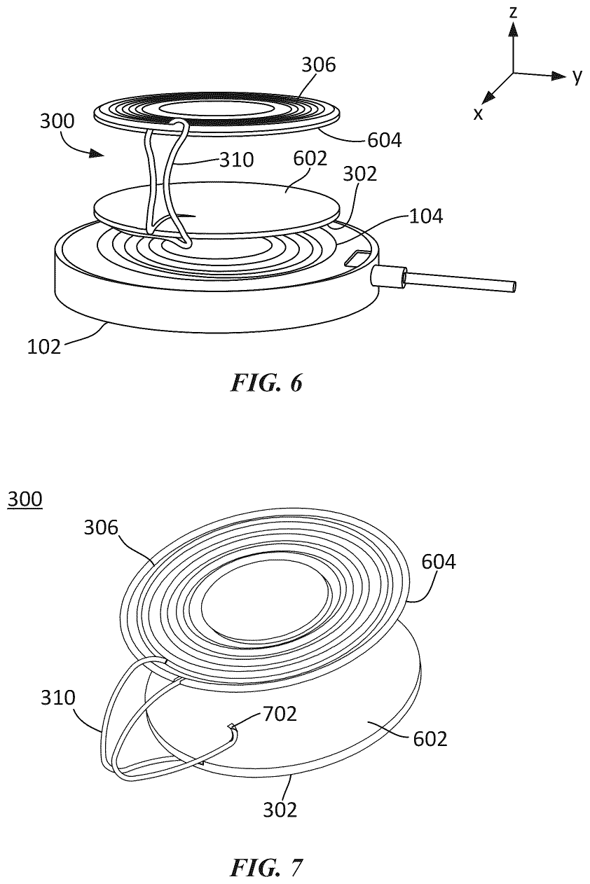

FIG. 6 illustrates the wireless power transfer relay 300 from another perspective, placed on top of the wireless power transmitter 102 with the mobile electronic device 100 omitted for clarity. In particular embodiments, the wireless power transfer relay 300 may be provided with one or more ferrite backings such as ferrite backings 602 and 604. As an example and not by way of limitation, as illustrated, the ferrite backing 602 may be placed on the side of the relay receiver coil 302 facing away from the wireless power transmitter 102, while the ferrite backing 604 may be placed on the side of the relay transmitter coil 306 facing away from the primary receiver coil 202 of the mobile electronic device 100. In particular embodiments, the ferrite backings 602 and 604 may be configured to occlude the magnetic field from the wireless power transmitter 102 beyond the relay receiver coil 302 to prevent it from interfering with the relay transmitter coil 306. In other words, the original magnetic field from the wireless power transmitter 102 may not pass to the relay transmitter coil 306 because it is shielded by the ferrite backing 602 and 604. Otherwise, the current induced by the magnetic field in the relay transmitter coil 306 would oppose the current in the relay receiver coil 302 (provided that the two relay coils 302 and 306 are wound in the same direction for example). To this end, as an example and not by way of limitation, the ferrite backings 602 and 604 may be made of ceramic or other suitable ferrite materials having desired magnetic permeability for shielding. In particular embodiments, the ferrite backing 602 and 604 may be configured to occlude the magnetic field generated by any of the coils, ensuring that the space between the relay coils 302 and 306, or the accessory device 312 in the space, does not experience any magnetic field (e.g., receives zero or near zero magnetic flux). In particular embodiments, the ferrite backings 602 and 604 may be continuous along the radial direction, forming a complete shield. In particular embodiments, the ferrite backings 602 and 604 may substantially be the same size as the associated relay coils 302 and 306. Alternatively, in particular embodiments, the ferrite backings 602 and 604 may be circumferentially larger than the associated relay coil 302 or 306 to establish better shielding. In particular embodiments, the ferrite backings 602 and 604 may be circular, elliptical, triangular, rectangular, or any other suitable shape for backing and shielding the coils as needed.

In particular embodiments, the ferrite backing 602 or 604 may be structured or machined with a pocket for the corresponding relay coil 302 or 306 to nest inside. As an example and not by way of limitation, surface of the ferrite backing 602 or 604 may not go beyond that of the associated relay coil 302 or 306. In other words, the surface of the ferrite backing 602 or 604 may stay flush to or sit short of the surface of the relay coil 302 or 306. Structured this way, it may be possible for the nested ferrite configuration to help with concentrating the magnetic flux, thereby producing a greater coupling or efficiency.

In particular embodiments, the relay receiver and transmitter coils 302 and 306 may be configured without the ferrite backing or optionally with only one ferrite backing. As an example and not by way of limitation, the two relay coils 302 and 306 may be wound in opposite directions—e.g., one clockwise and the other counterclockwise—such that the electrical current induced in the relay receiver coil 302 may go through the relay transmitter coil 306 in phase with the magnetic field originally produced by the wireless power transmitter 102. In this case, it may be desirable to separate the relay transmitter coil 306 far enough away from the relay receiver coil 302, or the wireless power transmitter 102, to minimize the influence of the undesired magnetic field from the wireless power transmitter 102 on the relay transmitter coil 306. Additionally, in particular embodiments, the relay transmitter coil 306 may be provided with fewer windings so that there is an inductance mismatch between the two relay coils 302 and 306. This may further help to avoid interference caused by the original magnetic field.

FIG. 7 shows a standalone view of the wireless power transfer relay 300. In particular embodiments, two legs of the relay receiver coil 302 may be directly connected to two corresponding legs of the relay transmitter coil 306, thereby forming the conductors 310 for electrical connection. As an example and not by way of limitation, the legs may be coated or covered with protective material to be insulated from the external environment. In particular embodiments, to accommodate the legs, the ferrite backings 602 and 604 may be slotted (see for example slot 702), grooved, or provided with other suitable openings to permit at least a portion of the legs to be received therein or passthrough. Alternatively, in particular embodiments, as already explained, other forms of the conductor 310 may be provided such as wires, pins, or other suitable electrical connectors for conducting electric power between the two relay coils 302 and 306. In particular embodiments, the legs may be rigid, providing a standoff to keep the relay coils 302 and 306 spaced apart at a fixed distance from each other. Alternatively, in particular embodiments, the legs may be flexible and have a fixed or adjustable length, allowing the mobile electronic device 100 to be positioned in a range of distance relative to the wireless power transmitter 102, offering greater convenience and flexibility.

In particular embodiments, the relay receiver coil 302 may be formed by a wire wound around in loops with two terminal ends extending out, and the relay transmitter coil 306 may be looped in a similar manner having two protruding ends. As an example and not by way of limitation, the ends of the relay coils 302 and 306 may be coupled together by means of soldering, adhering, crimping, or other suitable methods for establishing proper electrical connection. Alternatively, in particular embodiments, it may be possible to have a continuous wire that forms one coil (e.g., the relay receiver coil 302), extends an intermediate length, and then forms another coil (e.g., the relay transmitter coil 306).

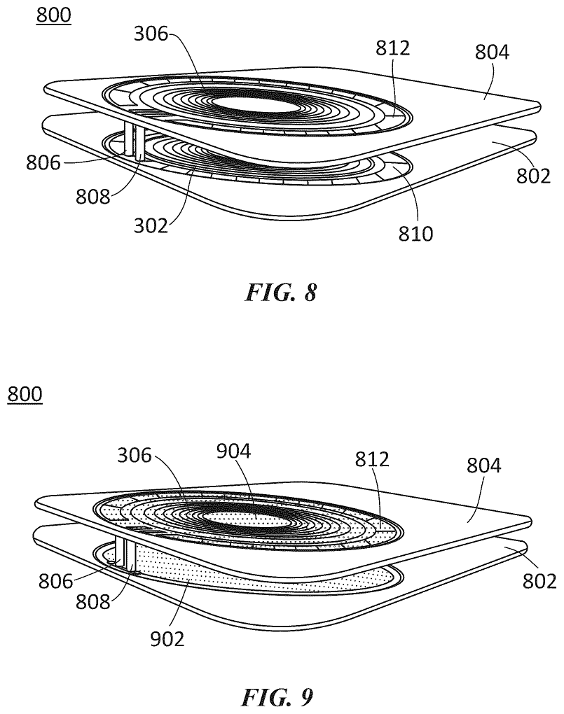

FIG. 8 illustrates an example wireless power transfer relay 800 in accordance with an embodiment of this disclosure, which may be configured as a multi-panel system. The wireless power transfer relay 800 may include similar features and components described above with reference to FIGS. 3-7 (such as those of the wireless power transfer relay 300) and may be compatible with various embodiments disclosed herein. In particular embodiments, the wireless power transfer relay 800 may include two pads or panels 802 and 804, one as the receiving platform 304 configured to be positioned in proximity to the wireless power transmitter 102 and the other as the transmitting platform 308 in proximity to the mobile electronic device 100.

In particular embodiments, the panels 802 and 804 may be modular such that an accessory device (such as a case, a grip, a wallet, a battery bank, etc.) or other suitable objects may be positioned between the panels 802 and 804. As an example and not by way of limitation, one or more accessory devices 312 may be attached, coupled, or otherwise positioned between the panels 802 and 804, for example, via magnets, latches, adhesives, pins, clamps, connectors, etc. As another example and not by way of limitation, objects such as payment cards, cash, coins, identification cards, or other personal items may be contained in the space between the panels 802 and 804. In particular embodiments, the relay receiver coil 302 and the relay transmitter coil 306 may respectively be embedded into or otherwise coupled to the corresponding panels 802 and 804. As an example and not by way of limitation, surfaces of the panels 802 and 804 may be flat with the relay coils 302 and 306 (i.e., embedded flush with no protrusions). Alternatively, surfaces of the panels 802 and 804 may extend beyond or stay short of the relay coils 302 and 306 if needed.

In particular embodiments, one or more conductors 310 may extend between the panels 802 and 804 and electrically connect the two relay coils 302 and 306. As an example and not by way of limitation, as shown, two pins 806 and 808 are employed to interface with the panels 802 and 804. Each pin connects a terminal of the relay receiver coil 302 with a terminal of the relay transmitter coil 306, establishing direct (e.g., wired) electrical connection between the two relay coils 302 and 306. As an example and not by way of limitation, the pin may be a spring-loaded pin (e.g., a pogo pin), a conductive contact, or other suitable electrical connectors. As another example and not by way of limitation, a flexible wire or bundle of wires may be used alternatively or in addition to the pin.

In particular embodiments, the wireless power transfer relay 800 may be configured to support a modular configuration between its two panels 802 and 804. As an example and not by way of limitation, the panels 802 and 804 may be electrically connected through a number of individual modules sandwiched in between, each having corresponding pins or conductors providing an electrical passthrough. Explaining further, the wireless power transfer relay 800 may allow multiple modules to be stacked between the panels 802 and 804, with the pins of adjacent panels or modules connected in series to enable power transmission therethrough. This allows the modules to be added or removed as needed (for example, if a user needs more or less container space for storing cards or other personal items), while still allowing wireless charging via the wireless power transfer relay 800. As an example and not by way of limitation, the pin may be configured with an integrated interface that is capable of both releasably connecting the panels or modules together and transmitting electrical power through the system.

The shape of the panels 802 and 804 may vary across embodiments. In particular embodiments, as illustrated, the panels 802 and 804 may generally be rectangular. In particular embodiments, although not illustrated, the panels 802 and 804 may be circular, elliptical, triangular, polygonal, non-polygonal, irregular in shape, etc. Material construction of the panels 802 and 804 may vary across embodiments. As an example and not by way of limitation, the panels 802 and 804 may be made of rigid materials such as plastic, metal, etc. As another example and not by way of limitation, the panels 802 and 804 may be made of deformable materials such as silicone or the like.

In particular embodiments, one or more magnet arrays—e.g., magnet arrays 810 or 812—may be coupled to one or more of the panels 802 or 804 and configured to assist in aligning the wireless power transfer relay 800 to the mobile electronic device 100 and/or the wireless power transmitter 102 for consistent charging. In particular embodiments, the magnet arrays 810 and 812 may circumferentially surround the corresponding relay coils 302 and 306. As an example and not by way of limitation, the magnet arrays 810 and 812 may have a larger diameter than the relay coils 302 and 306 to substantially enclose them. In particular embodiments, the magnet arrays 810 and 812 may correspond to the APPLE MAGSAFE magnetic standard. As an example and not by way of limitation, the inner diameter for the magnet arrays 810 and 812 may be about 46 mm, and the outer diameters may be 54.1 mm. Alternatively, in particular embodiments, the magnet arrays 810 and 812 may be configured larger or smaller as needed.

FIG. 9 illustrates the wireless power transfer relay 800 with the addition of ferrite backings 902 and 904 (shown as dotted area). Similar to the ferrite backings described above with reference to FIGS. 3-7, in particular embodiments, the ferrite backings 902 and 904 may be attached, coupled, or positioned on the inner sides of the panels 802 and 804, respectively. As an example and not by way of limitation, the ferrite backing 902 may cover the upper side of the relay receiver coil 302 (e.g., the side facing the relay transmitter coil 306), and the ferrite backing 904 may cover the lower side of the relay transmitter coil 306 (e.g., the side facing the relay receiver coil 302). As an example and not by way of limitation, as illustrated, the ferrite backings 902 and 904 may generally be circular in shape and extend across an area of the associated relay coils 302 and 306. Alternatively or additionally, the ferrite backings 902 and 904 may further cover the magnet arrays 810 and 812. In particular embodiments, the magnetic field originated from the wireless power transmitter 102 may be shielded by the ferrite backings 902 and 904 so that it may not pass beyond the relay receiver coil 302, preventing magnetic flux from entering into the space between the two panels 802 and 804, avoiding influencing the relay transmitter coil 306 as well as any accessories held between the panels 802 and 804.

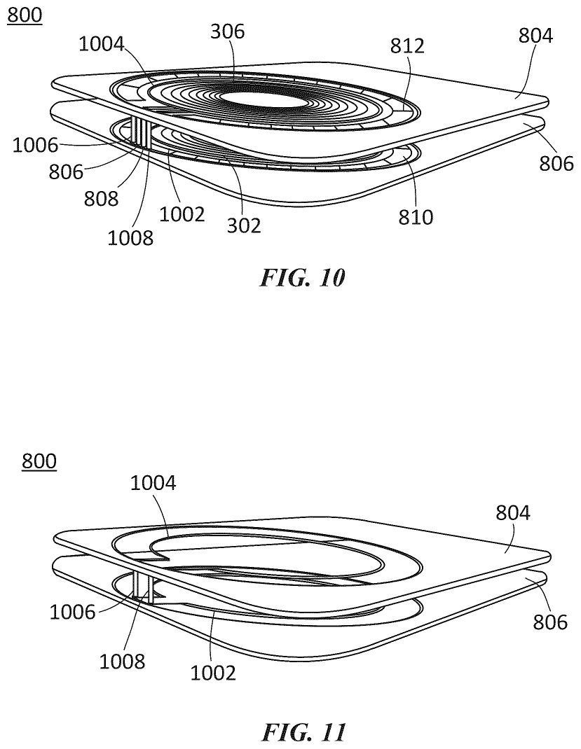

FIGS. 10 and 11 illustrate the wireless power transfer relay 800 with the addition of a pair of near-field communication (NFC) relay coils 1002 and 1004. Typically, for APPLE MAGSAFE enabled mobile electronic devices, an NFC coil may be looped around and positioned outside the primary receiver coil of the mobile electronic device, which may be used for data exchange, device authentication and pairing such as for example to identify accessories attached to the back of the mobile electronic device (e.g., cases, grips, wallets, etc.). For example, the official APPLE MAGSAFE accessories may trigger a visual indication on the mobile electronic device's screen when it has been properly identified. NFC technology may work similarly to wireless charging in that NFC may use magnetic induction to both power the NFC tag and read its contents. In particular embodiments, by configuring the wireless power transfer relay 800 with the NFC relay coils 1002 and 1004, it may be possible for NFC-embedded components to still pass their information through the wireless power transfer relay 800 without having to remove the attached accessory devices. As an example and not by way of limitation, this may be especially useful for tap payments, NFC signal identification, etc.

In particular embodiments, as illustrated, the NFC relay coils 1002 and 1004 may each be arranged around and encircle the relay receiver coil 302 and transmitter coil 306, respectively. In particular embodiments, the NFC relay coils 1002 and 1004 may be positioned inside the boundary of the magnet arrays 810 and 812, respectively (i.e., between the magnet arrays 810 and 812 and the relay coils 302 and 306). In particular embodiments, the NFC relay coils 1002 and 1004 may be electrically connected with each other via wires, leads, cables, pins, contacts, or other suitable connectors. As an example and not by way of limitation, two pins 1006 and 1008, which may be configured similarly to the pins 806 and 808, may be employed for coupling the NFC relay coils 1002 and 1004 together, establishing electrical connection therebetween. In particular embodiments, the NFC relay coils 1002 and 1004 may be embedded in the panels 802 and 804 in a way that they are concentric with the two embedded relay coils 302 and 306. Of course, other suitable positions are also envisioned by the disclosure for arranging the NFC coils depending on needs. As an example and not by way of limitation, instead of being embedded into the panels, the NFC coils may be separately provided. As another example and not by way of limitation, the NFC coils may be located close to a regular NFC transceiver of the mobile electronic device, which may for example be positioned near the top corner at the back of the mobile electronic device (e.g., near a camera of the mobile electronic device). In particular embodiments, while illustrated as having a single loop configuration (this can be more easily observed in FIG. 11 with the relay coils 302 and 306 and the magnet arrays 810 and 812 omitted for clarity), the NFC relay coil may be configured with multiple loops. In particular embodiments, the NFC relay coil may have a different number of windings, a different coil size or shape, or other suitable design parameters for NFC compatibility.

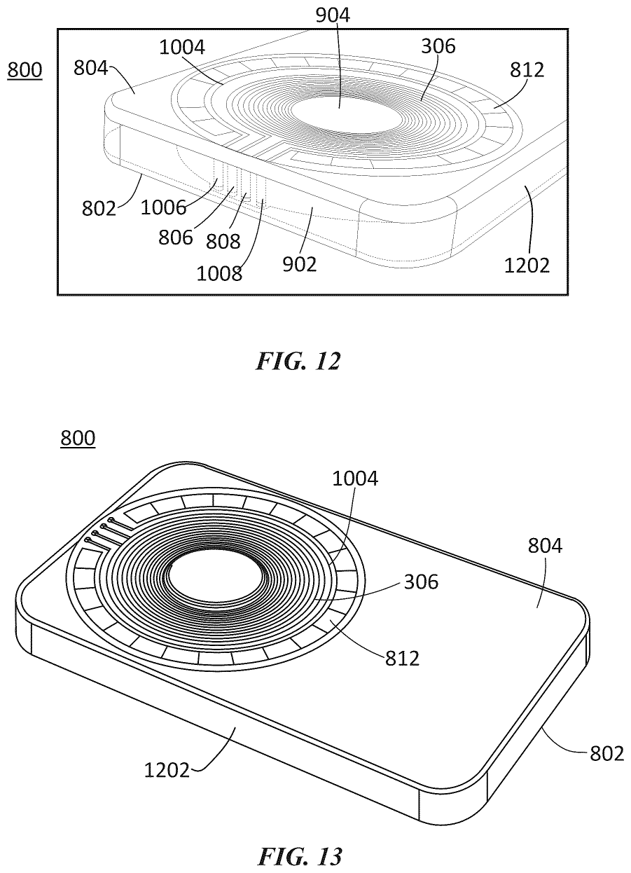

FIGS. 12 and 13 illustrate the wireless power transfer relay 800 configured as an integrated module. In particular embodiments, the wireless power transfer relay 800 may in general include the relay transmitter and receiver coils 302 and 306, the magnet arrays 810 and 812, the ferrite backings 902 and 904, and the NFC relay coils 1002 and 1004, all of which may be embedded into the two panels 802 and 804. Alternatively, in particular embodiments, some of the components may be provided independently from the panels 802 and 804 without necessarily being integrated into them. In particular embodiments, as illustrated, one or more side walls 1202 may be provided between the two panels 802 and 804 to enclose an interior space therebetween. In particular embodiments, one or more of the side walls 1202 may be provided with an opening, a slot, an aperture, or the like configured to provide access to the interior space, allowing objects such as payment cards, cash, coins, identification cards, or other personal items to be placed into the interior space. In other words, in particular embodiments, the wireless power transfer relay 800 may be configured as a container accessory for holding various objects and may stay attached to the mobile electronic device 100 during wireless charging (as well as NFC uses) without affecting energy transmission efficiency.

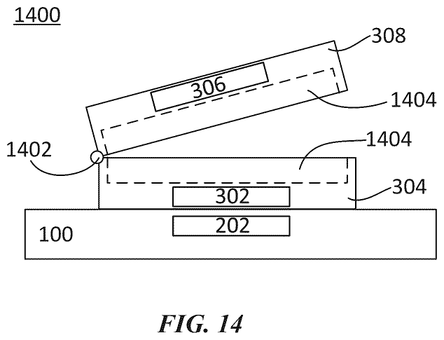

FIG. 14 illustrates an example wireless power transfer relay 1400 in accordance with an embodiment of this disclosure, which may be configured to be attached to the back of the mobile electronic device 100. The wireless power transfer relay 1400 may include similar features and components described above with reference to FIGS. 3-13 (such as those of the wireless power transfer relay 300 and 800) and may be compatible with various embodiments disclosed herein. In particular embodiments, the wireless power transfer relay 1400 may be within a device or container provided with a hinge 1402, which may be configured to movably connect the receiving platform 304 and the transmitting platform 308 together, allowing the platforms 304 and 308 to pivot or rotate angularly relative to each other, thereby opening and closing a device or container which contains wireless power transfer relay 1400 as needed. As an example and not by way of limitation, the hinge 1402 may be a friction hinge, a butt hinge, a bearing hinge, a piano hinge, a pivot hinge, or other suitable mechanical connectors. As an example and not by way of limitation, the hinge 1402 may be rigid, providing a limited degree of rotation of the receiving platform 304 and the transmitting platform 308. Alternatively, the hinge 1402 may be flexible so as to allow the platforms 304 and 308 to be separated at a variable degree. In particular embodiments, the conductor 310 (such as in the form of wires) may be routed through the hinge 1402 so as to electrically connect the relay receiver coil 302 in the receiving platform 304 with the relay transmitter coil 306 in the transmitting platform 308 for power transmission. As an example and not by way of limitation, by connecting the relay receiver coil 302 and the relay transmitter coil 306, the wireless power transfer relay 1400 may facilitate charging regardless if the hinged container is in the opened or closed state.

In particular embodiments, one or more of the receiving platform 304 or the transmitting platform 308 may include a container space 1404 for receiving objects such as personal items or accessories. As an example and not by way of limitation, as illustrated, the receiving platform 304 and the transmitting platform 308 may each be hollowed out to provide the container space 1404. As an example and not by way of limitation, although not illustrated, the receiving platform 304 and the transmitting platform 308 may be provided an opening, a slot, an aperture, etc., for providing access to the container space 1404. In particular embodiments, the container space 1404 may include one or more compartments or layers, each suitable for receiving an individual item. This way, the wireless power transfer relay 1400 may function similarly to a wallet, while still allowing it to remain attached to the mobile electronic device 100 and enabling effective wireless charging. In particular embodiments, the container space 1404 may have a thickness that would affect wireless power transfer efficiency. In particular embodiments, the container space 1404 may have a thickness that is greater than the maximum allowable distance for wireless charging as discussed above. In particular embodiments, the container space 1404 may have a thickness that would still permit wireless power transfer.

In particular embodiments, one or more of the receiving platform 304 or the transmitting platform 308 may be made of deformable or flexible material. As an example and not by way of limitation, as the number or thickness of items inserted into the container space 1404 increases, the wireless power transfer relay 1400 may correspondingly expand to accommodate the items. Although described in this matter, it is also contemplated that in particular embodiments, one or more of the receiving platform 304 or the transmitting platform 308 may alternatively be rigid with a fixed thickness.

FIG. 15 illustrates an example wireless power transfer relay 1500 in accordance with an embodiment of this disclosure. The wireless power transfer relay 1500 may include similar features and components described above with reference to FIGS. 3-14 (such as those of the wireless power transfer relay 300, 800, 1400) and may be compatible with various embodiments disclosed herein. In particular embodiments, the receiving platform 304 and the transmitting platform 308 may be located transversely relative to each other (e.g., in the x-y plane as shown), with the conductor 310 connected between the receiving platform 304 and the transmitting platform 308 and electrically connecting the relay receiver coil 302 and the relay transmitter coil 306. As an example and not by way of limitation, the conductor 310 may include a flexible wire, allowing the receiving and transmitting platforms 304 and 308 to be movable relative to each other. Alternatively or additionally, the conductor 310 may be rigid if desired. In particular embodiments, the conductor 310 may have a fixed length, separating the receiving and transmitting platforms 304 and 308 in a fixed range of distance. In particular embodiments, the conductor 310 may have an adjustable length (for example, by means of a retractable wiring system).

FIG. 16 illustrates an example use case of the wireless power transfer relay 1500, which may be configured to relay energy between the mobile electronic device 100 and an accessory electronic device 1602. In particular embodiments, the relay receiver coil 302 of the wireless power transfer relay 1500 may be configured to receive wireless power from the mobile electronic device 100. As an example and not by way of limitation, the mobile electronic device 100 may be configured with a power-share function, which may also be known as reverse wireless charging, for providing wireless power through the wireless power transfer relay 1500 to other accessory electronic devices, e.g., the accessory electronic device 1602. Specifically, in particular embodiments, during power sharing, the primary receiver coil 202 of the mobile electronic device 100 may function in a way similar to a transmitter coil. As an example and not by way of limitation, the primary receiver coil 202 may receive an AC signal (e.g., from a battery of the mobile electronic device 100), which may generate an alternating magnetic field around the primary receiver coil 202. In particular embodiments, the wireless power transfer relay 1500 may be configured to capture the magnetic field via its relay receiver coil 302 and convert the captured energy into electrical current. The induced current may be conducted, for example, via the conductor 310, to the relay transmitter coil 306, which may re-radiate the power to wirelessly power the accessory electronic device 1602. In particular embodiments, the wireless power transfer relay 1500 may be configured to communicate with the mobile electronic device 100, for example, to negotiate a specified amount of wireless power to be received. As an example and not by way of limitation, the amount of wireless power received by the relay receiver coil 302 may be sufficient to power the accessory electronic device 1602, while avoiding overheating the battery of the mobile electronic device 100 or causing damage to other components in the system. As an example and not by way of limitation, the amount of wireless power received by the relay receiver coil 302 may be less than a threshold amount for triggering FOD of the mobile electronic device 100, thus preventing the power-share function from unintentionally being ceased or reduced to a lower output level. In particular embodiments, the wireless power transfer relay 1500 itself may be configured with FOD functionality. As an example and not by way of limitation, the wireless power transfer relay 1500 may be able to detect if there exists a power mismatch between the wireless power transfer relay 1500 and the mobile electronic device 100, indicating possible presence of a foreign object. If so, as an example and not by way of limitation, the wireless power transfer relay 1500 may communicate with the mobile electronic device 100 to adjust or terminate power sharing.

In particular embodiments, the accessory electronic device 1602 may include one or more of a light-emitting diode (LED) element, a fan, a battery, a battery charger, a display, a device tracker, a speaker, an air tag, or other suitable electronic devices associated with the mobile electronic device 100. In particular embodiments, the wireless power transfer relay 1500 may be configured to relay power from the mobile electronic device 100 (e.g., using its power-sharing feature) to another mobile electronic device.

In particular embodiments, as already discussed, the wireless power transfer relay 1500 may be configured with one or more coils that are suitable for NFC technology. As an example and not by way of limitation, the wireless power transfer relay 1500 may be configured to relay the NFC signal emitted from the mobile electronic device 100, which may be used for data exchange, device authentication and pairing, etc. As an example and not by way of limitation, the NFC signal may also be used for low-power relay through the wireless power transfer relay 1500, for example, to power small electronics that need a relatively low power level.

FIG. 17 illustrates another example use case of the wireless power transfer relay 1500, which may be configured to relay energy between the wireless power transmitter 102 and an electronic device 1702. In particular embodiments, the wireless power transmitter 102 may be at a fixed location such as embedded under a surface (for example beneath a table surface or countertop) and may be difficult to be repositioned. To allow a user to wirelessly charge the electronic device 1702 in a wider, more flexible range, the wireless power transfer relay 1500 may be placed on the surface, with its relay receiver coil 302 close to the wireless power transmitter 102 and the relay transmitter coil 306 at any desired location for wirelessly charging the electronic device 1702. In particular embodiments, the relay transmitter coil 306 may be movable relative to the relay receiver coil 302, allowing power to be relayed at any desired distance or in any desired range of distance for charging the electronic device 1702. In particular embodiments, the wireless power transfer relay 1500 may be configured to relay power through a surface such as a table surface or countertop. As an example and not by way of limitation, the relay receiver coil 302 may be located under a countertop, and the relay transmitter coil 306 may be movable on the countertop or slightly below the countertop surface. As an example and not by way of limitation, the transmitting platform 308 having the relay transmitter coil 306 may be configured as an induction pad, an induction dock, other suitable structures for wirelessly charging the electronic device 1702. In particular embodiments, the electronic device 1702 may not necessarily be limited to a mobile electronic device but may include one or more of a household electrical appliance, a personal care device, or any other electrical device that uses wireless power transfer technology.

### Recitation of Embodiments

Embodiment 1. A wireless power transfer relay for coupling to a mobile electronic device, the wireless power transfer relay comprising: a receiving platform having a relay receiver coil, the relay receiver coil configured in proximity to a primary transmitter coil of a wireless power transmitter to wirelessly receive power from the primary transmitter coil; a transmitting platform having a relay transmitter coil, the relay transmitter coil configured in proximity to a primary receiver coil of the mobile electronic device to wirelessly transmit power to the primary receiver coil; and a conductor coupled between the receiving platform and the transmitting platform and electrically coupling the relay receiver coil and the relay transmitter coil.

Embodiment 2. The wireless power transfer relay of Embodiment 1, wherein the relay receiver coil and the relay transmitter coil are spaced apart by a distance that would affect wireless power transfer efficiency.

Embodiment 3. The wireless power transfer relay of Embodiment 2, wherein the distance is greater than a maximum allowable distance for wireless charging.

Embodiment 4. The wireless power transfer relay of any one of Embodiments 1-3, wherein the relay receiver coil is configured to wirelessly receive a maximum amount of power from the primary transmitter coil.

Embodiment 5. The wireless power transfer relay of any one of Embodiments 1-4, wherein the relay receiver coil and the relay transmitter coil are configured for induction charging.

Embodiment 6. The wireless power transfer relay of any one of Embodiments 1-5, further comprising: one or more ferrite backings coupled to one or more of the receiving platform or the transmitting platform, the one or more ferrite backings configured to shield a magnetic field generated by the primary transmitter coil beyond the relay receiver coil.

Embodiment 7. The wireless power transfer relay of any one of Embodiments 1-6, further comprising: one or more magnet arrays coupled to one or more of the receiving platform or the transmitting platform for position alignment.

Embodiment 8. The wireless power transfer relay of any one of Embodiments 1-7, further comprising: a pair of near-field communication (NFC) relay coils configured to relay an NFC signal between the wireless power transmitter and the mobile electronic device.

Embodiment 9. The wireless power transfer relay of any one of Embodiments 1-8, wherein the conductor comprises one or more of a wire, a pin, or a contact.

Embodiment 10. The wireless power transfer relay of any one of Embodiments 1-9, wherein the receiving platform and the transmitting platform are movably connected via a hinge.

Embodiment 11. The wireless power transfer relay of any one of Embodiments 1-10, further comprising: an accessory device positioned between the receiving platform and the transmitting platform.

Embodiment 12. The wireless power transfer relay of Embodiment 11, wherein the accessory device comprises one or more of a case, a grip, or a wallet.

Embodiment 13. The wireless power transfer relay of any one of Embodiments 1-12, further comprising: a container space positioned between the receiving platform and the transmitting platform.

Embodiment 14. The wireless power transfer relay of any one of Embodiments 1-13, further comprising: a capacitor connected to the relay transmitter coil, the capacitor configured to adjust a resonant frequency of the relay transmitter coil.

Embodiment 15. The wireless power transfer relay of any one of Embodiments 1-14, further comprising: a microcontroller unit connected to the relay transmitter coil, the microcontroller unit configured to monitor an operating frequency of the wireless power transmitter or the mobile electronic device.

Embodiment 16. The wireless power transfer relay of any one of Embodiments 1-15, wherein the transmitting platform is configured to be coupled to the mobile electronic device via one or more of a magnet, an adhesive, or a mechanical connector.

Embodiment 17. The wireless power transfer relay of any one of Embodiments 1-16, wherein the receiving platform and the transmitting platform are separable from each other.

Embodiment 18. The wireless power transfer relay of any one of Embodiments 1-17, wherein the relay receiver coil and the relay transmitter coil are spaced apart in an axial direction.

Embodiment 19. The wireless power transfer relay of any one of Embodiments 1-18, wherein the relay receiver coil and the relay transmitter coil are spaced apart in a transverse direction.

Embodiment 20. A wireless power transfer relay for coupling to a mobile electronic device, the wireless power transfer relay comprising: a receiving platform having a relay receiver coil, the relay receiver coil configured in proximity to a primary transmitter coil of a wireless power transmitter to wirelessly receive power from the primary transmitter coil; a transmitting platform having a relay transmitter coil, the relay transmitter coil configured in proximity to a primary receiver coil of the mobile electronic device to wirelessly transmit power to the primary receiver coil; a conductor coupled between the receiving platform and the transmitting platform and electrically coupling the relay receiver coil and the relay transmitter coil; and an accessory device positioned between the receiving platform and the transmitting platform, the accessory device having a thickness that would affect wireless power transfer efficiency.

Embodiment 21. A wireless power transfer relay for coupling to a mobile electronic device, the wireless power transfer relay comprising: a receiving platform having a relay receiver coil, the relay receiver coil configured in proximity to a primary transmitter coil of a wireless power transmitter to wirelessly receive power from the primary transmitter coil; a transmitting platform having a relay transmitter coil, the relay transmitter coil configured in proximity to a primary receiver coil of the mobile electronic device to wirelessly transmit power to the primary receiver coil; a conductor coupled between the receiving platform and the transmitting platform and electrically coupling the relay receiver coil and the relay transmitter coil; and a container space positioned between the receiving platform and the transmitting platform, the container space having a thickness that would affect wireless power transfer efficiency.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A wireless power transfer relay for coupling to a mobile electronic device, the wireless power transfer relay comprising:
a receiving platform having a relay receiver coil, the relay receiver coil configured in proximity to a primary transmitter coil of a wireless power transmitter to wirelessly receive power from the primary transmitter coil;
a transmitting platform having a relay transmitter coil, the relay transmitter coil configured in proximity to a primary receiver coil of the mobile electronic device to wirelessly transmit power to the primary receiver coil; and
a conductor coupled between the receiving platform and the transmitting platform and electrically coupling the relay receiver coil and the relay transmitter coil.

2. The wireless power transfer relay of claim 1, wherein the relay receiver coil and the relay transmitter coil are spaced apart by a distance that would affect wireless power transfer efficiency.

3. The wireless power transfer relay of claim 2, wherein the distance is greater than a maximum allowable distance for wireless charging.

4. The wireless power transfer relay of claim 1, wherein the relay receiver coil is configured to wirelessly receive a maximum amount of power from the primary transmitter coil.

5. The wireless power transfer relay of claim 1, wherein the relay receiver coil and the relay transmitter coil are configured for induction charging.

6. The wireless power transfer relay of claim 1, further comprising:
one or more ferrite backings coupled to one or more of the receiving platform or the transmitting platform, the one or more ferrite backings configured to shield a magnetic field generated by the primary transmitter coil beyond the relay receiver coil.

7. The wireless power transfer relay of claim 1, further comprising:
one or more magnet arrays coupled to one or more of the receiving platform or the transmitting platform for position alignment.

8. The wireless power transfer relay of claim 1, further comprising:
a pair of near-field communication (NFC) relay coils configured to relay an NFC signal between the wireless power transmitter and the mobile electronic device.

9. The wireless power transfer relay of claim 1, wherein the conductor comprises one or more of a wire, a pin, or a contact.

10. The wireless power transfer relay of claim 1, wherein the receiving platform and the transmitting platform are movably connected via a hinge.

11. The wireless power transfer relay of claim 1, further comprising:
an accessory device positioned between the receiving platform and the transmitting platform.

12. The wireless power transfer relay of claim 11, wherein the accessory device comprises one or more of a case, a grip, or a wallet.

13. The wireless power transfer relay of claim 1, further comprising:
a container space positioned between the receiving platform and the transmitting platform.

14. The wireless power transfer relay of claim 1, further comprising:
a capacitor connected to the relay transmitter coil, the capacitor configured to adjust a resonant frequency of the relay transmitter coil.

15. The wireless power transfer relay of claim 1, further comprising:
a microcontroller unit connected to the relay transmitter coil, the microcontroller unit configured to monitor an operating frequency of the wireless power transmitter or the mobile electronic device.

16. The wireless power transfer relay of claim 1, wherein the transmitting platform is configured to be coupled to the mobile electronic device via one or more of a magnet, an adhesive, or a mechanical connector.

17. The wireless power transfer relay of claim 1, wherein the receiving platform and the transmitting platform are separable from each other.

18. The wireless power transfer relay of claim 1, wherein the relay receiver coil and the relay transmitter coil are spaced apart in an axial direction.

19. The wireless power transfer relay of claim 1, wherein the relay receiver coil and the relay transmitter coil are spaced apart in a transverse direction.

20. A wireless power transfer relay for coupling to a mobile electronic device, the wireless power transfer relay comprising:
a receiving platform having a relay receiver coil, the relay receiver coil configured in proximity to a primary transmitter coil of a wireless power transmitter to wirelessly receive power from the primary transmitter coil;
a transmitting platform having a relay transmitter coil, the relay transmitter coil configured in proximity to a primary receiver coil of the mobile electronic device to wirelessly transmit power to the primary receiver coil;
a conductor coupled between the receiving platform and the transmitting platform and electrically coupling the relay receiver coil and the relay transmitter coil; and
an accessory device positioned between the receiving platform and the transmitting platform, the accessory device having a thickness that would affect wireless power transfer efficiency.

21. A wireless power transfer relay for coupling to a mobile electronic device, the wireless power transfer relay comprising:
a receiving platform having a relay receiver coil, the relay receiver coil configured in proximity to a primary transmitter coil of a wireless power transmitter to wirelessly receive power from the primary transmitter coil;
a transmitting platform having a relay transmitter coil, the relay transmitter coil configured in proximity to a primary receiver coil of the mobile electronic device to wirelessly transmit power to the primary receiver coil;
a conductor coupled between the receiving platform and the transmitting platform and electrically coupling the relay receiver coil and the relay transmitter coil; and
a container space positioned between the receiving platform and the transmitting platform, the container space having a thickness that would affect wireless power transfer efficiency.
